(19) United States
(12) Patent Application Publication
(10) Pub. No.: US 2022/0261059 A1
(43) Pub. Date: Aug. 18, 2022

(54) System and Method for Automated Adaptive Operation to Achieve Optimized Power Management on Internet of Things Devices

(71) Applicants: Stanislav Rostislavovych Bobovych, New Market, MD (US); Tzeta Tsao, Boyds, MD (US); Minakshisundaran B. Anand, Germantown, MD (US); Tim Winter, Frederick, MD (US)

(72) Inventors: Stanislav Rostislavovych Bobovych, New Market, MD (US); Tzeta Tsao, Boyds, MD (US); Minakshisundaran B. Anand, Germantown, MD (US); Tim Winter, Frederick, MD (US)

(21) Appl. No.: 17/666,514

(22) Filed: Feb. 7, 2022

Related U.S. Application Data
(60) Provisional application No. 63/146,504, filed on Feb. 5, 2021.

(51) Int. Cl. G06F 1/329; G06F 9/50; G05B 19/042

(52) U.S. Cl. CPC G06F 1/329; G05B 2219/2639; G05B 19/042; G06F 9/5094

(57) ABSTRACT

The present invention provides a system for observing power or energy availability for a gateway device and the power or energy consumption of each component or device within or connected to the gateway device. The gateway device of the present invention can then learn the usage patterns of the software modules and devices and then predict the power utilization based on various usage plans. The gateway device can then plan or build an energy consumption schema and implement the energy consumption schema to control power utilization by the gateway device and its related peripheral devices. The gateway device can also communicate with other gateway devices to share power plant data, utilization schemas, or to off load or on board data tasks. The gateway device can dynamically self-optimize to restrict or permit power plant usage based on forecasts derived from past behavior and predicted future behavior and demand predictions triggered by application usage.

### RELATED APPLICATION

This application claims priority to U.S. Provisional Application 63/146,504 filed on Feb. 5, 2021, entitled “System and Method for Automated Adaptive Operation To Achieve Optimized Power Management On Internet of Things Devices”, the entirety of which is incorporated herein.

### BACKGROUND OF THE INVENTION

The present invention relates to the field of computing, and more specifically to a method of operating and managing an Internet of Things (IoT) device within an IoT system with respect to the planning and constrained utilization of energy from a power plant by energy consuming operations carried out by the hardware and software of the IoT device. Further, the invention enables such operation of hardware and software of the IoT device to be modulated based on prediction of available energy supply from the power plant and predicted demand profiles from the IoT device, where the technique of modulation can influence the operation of the IoT device to satisfy operational goals within the constraints of the energy that can be supplied from the power plant.

A near universal prerequisite for enabling IoT solutions is consideration of the energy supply of the IoT device at the edge. IoT solutions that may be feasible in terms of enabling technology and capabilities can be infeasible in terms of the required power plant and associated cost. In order to feasibly apply IoT technologies to enable new solution spaces, a means to utilize the power plant more optimally, to adjust behavior to limit or enable operations based on the state and constraints of that power plant, and to do so autonomously is needed. The present invention addresses this need.

Traditional IoT solutions may include power plants that source energy from a main supply (line powered), a local storage capability (e.g., battery powered or capacitive storage), a means of power generation (e.g., solar charging, energy harvesting), and sometimes a hybrid solution that includes a mix of the prior elements. Based on the power plant energy which may be plentiful (always available with no constraints) or constrained in some way (e.g., limited capacity that must be used sparingly, or limited capacity that may be restored, but that restoration may depend on time and external factors, e.g., weather). A key goal is to sustain the operation of the IoT device in a predictable way, perhaps operating in a degraded mode, based on the state of the power plant, and to adjust the hardware and software operation accordingly so as to continue to be available and operating in a predictable manner as long as possible before depleting the power plant to the point where operation is no longer possible.

Current solutions to power plant management often involve a user who, upon reviewing power availability information from a device, determines how to resolve low power situations (referred to herein as a ‘user-in-the-loop’). This is familiar to users of laptops or cell phones where the state of the power plant (e.g., battery) is monitored and the information of power depletion is made available to the user who may then take some corrective action or decision (i.e., shut down power hungry applications, plug in a charger or some similar step). Typically, this decision by the user is based on a somewhat coarse estimation of the battery state, which is measured and approximated in conjunction with charge/discharge cycles, sometimes augmented with an energy metering capability such as a coulomb counter. In these cases, the computer or device can advise when the power is ‘low’ but is often limited or unable to autonomously take fine-grained power-conserving steps, ultimately requiring the user to take corrective action. Some degree of coarse autonomy can sometimes be configured as a matter of policy by the user. For example, when power drops below 15% turn off the cellular modem. However, refined or fine-grained policies in terms of threshold actions (e.g., different constraints applied at 75%, 50%, 30%, 15%, 5% of charge, for example) or application control (e.g., an application that is specifically able to change operation based on the state of the supply) are not typical. In the case of a device, such as a phone or a laptop, autonomous strategies are also less effective because from moment to moment the user may ultimately have different priorities (e.g., ‘I need to prioritize finishing this draft document’, ‘I need to check email’, ‘I need to access the web’) that are not easily anticipated or predictable. Thus, for typical devices the user-in-the-loop strategy is often the most effective strategy in those kind of use cases.

However, the IoT device or IoT gateway of the present invention is different from typical consumer devices because to be effective they need to operate with a large degree of autonomy. Further, IoT devices are often located in remote locations not accessible, or frequently accessible, to a user. If a user-in-the-loop is required for basic operations of an IoT gateway device, then the technology will not be able to scale well or will not be cost effective. Thus, ‘user-in-the-loop’ is not a workable solution for IoT systems, and importantly, the IoT gateway device.

A key enabling distinction between IoT devices and typical consumer devices is that IoT devices, most of the time, perform well defined and periodic tasks. The IoT gateway typically carries out a set of tasks over and over on a predictable schedule, which leads to largely predictable aggregate energy use, which in turn can be attributed to the sequences of operations carried out in support of each task. What is needed is an IoT gateway device that is rarely accessed but can observe, learn, predict, and plan for upcoming demands on a power plant. The present invention overcomes these technical problems by providing an IoT gateway device which works autonomously to observe, learn, predict, and plan for upcoming power demands on a power plant and implements a plan or schema to maximize efficiently of power use at the IoT edge.

### SUMMARY OF THE INVENTION

The present invention provides an exemplary system that is able to support automated and adaptive operations in order to match an available energy supply from a power plant to the energy consumption of an IoT device in terms of both hardware and software components.

The present invention provides an IoT gateway device which is enabled by a power plant that is instrumented for measurement. The power plant supplies power to a load (myriad of powered devices), which includes the embedded IoT gateway device including its hardware. Typically, a power plant supplies power in the form of electrical energy as characterized by voltage and current which varies over time. A rechargeable power plant further can produce energy to fill an energy reservoir, such as a solar panel with a charge controller that can recharge a battery. In the case of a solar power plant, a charge controller will typically be employed to intelligently charge a battery based on the energy being produced by a solar panel, which varies according to environmental conditions, coupled with knowledge of the battery chemistry and battery state-of-charge to achieve optimum energy production. In the case of a rechargeable power plant such as a solar/battery plant, the power plant is further instrumented to measure parameters related to the energy production, such as produced voltage, current, charge efficiency, or similar characteristics. Broadly then the method includes to measure and record information from an instrumented power plant, including but not limited to time varying energy production parameters and time varying energy consumption parameters (from the perspective of the power plant). These parameters are acquired at least periodically and stored in a non-volatile storage such as a flash-memory backed database. Given the time series history of the production and consumption parameters and knowledge of the energy reservoir, e.g., a battery, a model can be constructed and evaluated that provides an estimation of 1) the energy state of the power plant, e.g., how much energy can be sourced before depletion and 2) a predictive model of energy availability over time, e.g., how much energy can be restored throughout the day from a solar panel in the present environment. This information will be utilized by the invention as one component of the necessary inputs to the power management method.

The proposed method is further enabled by an operating system and operating system components (such as kernel, device drivers, etc.) that are instrumented for fine-grained power control of peripherals and hardware components. This instrumentation includes software or software modules, devices, components, or other means to both activate and deactivate hardware components/peripherals based on software requests or control, and to manage the fine-grained state as applicable to those hardware components. For example, an Ethernet interface may be disabled, idle, or in a transmit/receive (i.e., transceiving) state, each of which will have a different power consumption profile. A CPU may consist of several cores, each of which may be activated or deactivated, and when active may be operating at one of a possible number of clock frequencies, all of which in turn will influence the fine-grained power consumption state of the CPU. A cellular modem may be disabled, idle, online, or in any one of a number of power saving modes of operation, each of which will influence the fine-grained power consumption state of the cellular modem. The operating system is responsible to activate/deactivate hardware components, including but not limited to those examples listed here. The operating system will typically activate/deactivate hardware components based on a static configuration or demand from application software components that are utilizing the operating system to gain access to capabilities supported by the hardware, e.g., to perform computation on the CPU or to access the Internet via a cellular modem. In the present invention the operating system is instrumented to track and record when each element of power-consuming hardware is enabled/disabled and in what power-consuming state the hardware element is in during operation, such that a state vector representing the aggregate fine-grained power state of all major power-consuming hardware elements within the system can be constructed and maintained. As this state vector evolves, it is further recorded as a time-series history of how the power demands from the system hardware change over time. In addition, the operating system software is further instrumented such that application component operations which result in changes to the hardware power state, e.g., to change the state of a hardware peripheral in response to an application demand, can be noted and attributed to the application. Thus, there is a time-series record of how the hardware power state evolves over time and correlated with application operations that lead to that power state change. The invention thus collects the information on how fine-grained application and operating system behavior influences fine-grained power consumption at the hardware level.

Further, in consideration of the power state history and attribution of power consumption to application and operating system operations over time, there is a basis to predict which application operations will consume power in the future, how frequently, and how much power will be consumed. This is further enabled, as noted above, by the fact that IoT devices tend to run applications and procedures that are predictable and periodic by their nature.

Additionally, the proposed method can leverage external information that may modify or inform the predictive modeling and power management strategy. The method may communicate to a remote server to send information on the present power plant state, the various power supply and consumption histories, information on the historical management strategy, and parameters related to the predictive modeling of the supply and consumption trends. The method may further receive such information from a remote server where that information pertains to the same procedures carried out on peer IoT nodes that have implemented the same method. This information can be used to further tweak and tune the predictive modeling and management strategy. Further the method can receive information from a remote server comprised of additional external information that may inform and tune the predictive modeling, for example weather prediction information that can be used to tune the power plant supply model for a battery power plant with a solar recharging capability.

Given the information and models for the power plant state, supply, consumption, and system power state annotated with application and operating system software attribution, the method can predict how the future power usage will evolve given the constraints of the power plant and under particular operating use case scenarios. The method can then finally be applied in consideration of goals and constraints provided by a system operator as part of system provisioning/configuration. Goals and constraints may include, for example, to prioritize certain application software operations as critical priority, others as high priority, and others as low priority. They may include, for example, goals for how many days of autonomy that the system should be able to operate with a solar panel/battery power plant in the case where there is no usable sunlight for several days. They may include, for example, a preference to record data but not report data over a high-power WAN connection when the power plant is ascertained to be depleting and wait for that depletion to be restored before further undertaking high powered operations. In consideration of the goals and constrains, the present invention can compute a strategy for managing the system hardware in order to minimize power consumption while still meeting the goals and constraints. If a given system operating profile cannot be sustained under the present state of the power plant, then the computation can be made to determine which application layer operations should be deferred or skipped, based for example on priority, in order sustain higher priority operations in the face of limited energy supply. By leveraging the fine grained power consumption information related to system hardware and software state, the invention is able to permute combinations of what hardware components are required by application operations, what hardware components can have their operation curtailed or inhibited, and what application operations can be inhibited in turn—in order to arrive at an optimum envelope for what system power consumption profile can be sustained while still meeting the goals and constraints under the present state and future prediction of the power plant energy. Notably the system application operations can be reconfigured, added to, or removed as part of the normal course of operating the IoT device, and the invention will be able to observe and plan accordingly to still operate within the desired power consumption envelope, as long as such operation is feasible—there is no need for a system operator to micromanage the power management in the common case.

Based on the computation of the power management plan, the invention can assert mandatory or discretionary signals to the operating system and software components. Mandatory signals will cause hardware components/peripherals to be restricted from entering or operating in certain states, typically to restrict from entering high power consuming states. Discretionary signals can be sent to application software such that the software may cooperatively curtail certain operations under the discretionary suggestion. Mandatory and discretionary signals can also be deasserted, the opposite of assert, in order to permit higher power operation when, for example, the energy supply is restored.

A further capability enabled by the invention pertains to identifying possible anomalous operation which may be indicative of a fault or a security breach. In particular, since the invention is able to assess, identify, predict, and track the typical operating patterns of the IoT device, if something in those operating patterns changes in an unexpected way, for example by crossing a percent change or threshold of energy consumption as compared to historical and predicted trends, then the IoT device may be flagged as operating in an anomalous state. Hardware faults, misconfigurations, or security compromises could be the root cause of such anomalous behavior. Leveraging the invention allows such changes in behavior to be flagged and reported for further investigation by a system operator.

The present invention provides a system and method for automated adaptive operation of a IoT gateway device to achieve battery usage optimization. Traditional IoT components comprise line-powered and battery-powered devices. However, battery powered IoT devices have broader application allowing more diverse implementations since line power may not be available. Often, when line power is available it may be impractical to use, based on installation cost or other constraints. The present invention enables these battery powered IoT devices to avoid the ‘user-in-the-loop’ scenario by providing an automated battery usage management system at the edge. The present invention also avoids the need to oversize the battery of devices avoiding additional cost. The present invention provides an IoT gateway device which helps to self-optimize the devices to be more efficient on battery use in a dynamic way, by progressively modifying behavior (demand) based on how much battery is expected to be available (supply).

The present invention is dynamic and able to perform more work more frequently when energy is plentiful and then conserve power during periods when energy is less plentiful. The present invention provides an IoT gateway device which can prioritize operations based on the power needs such that a minimum necessary degree of functionality can be guaranteed over a longer time interval when battery energy looks scarce, but ramp back up when batter energy returns (i.e., when the battery is recharged).

The present invention provides an IoT gateway device which observes, learns, and implements an energy efficient plan or scheme in automated process. The IoT gateway device is also configurable allowing administrators or users to change parameters or modify the use cases which adjusts the system to behave in a controlled and intelligent way. The IoT gateway device is able to forecast future energy needs based on knowledge and observation of the periodic patterns. The IoT gateway device may gain energy efficiencies through control of the various applications based on prioritization of when to wake/sleep/acquire/report/etc., based upon cues from energy forecast. The IoT gateway device may block certain operations independently of the application based on cues from energy forecast (i.e., mandatory controls). As the energy forecast evolves, the overall system can modify its behavior to consume more or less energy.

The present invention may also modify operations to meet some bounding constraint, for example: (a) ‘I need N days of autonomous operation before the battery fails’; (b) ‘I need to always reserve Y energy to handle an alarm condition should it occur’; (c) ‘These operations are high priority, those operations are medium, the rest are low”; (d) “do as much as you can with the energy you have but shed lower priority operations if we are going to fall below a specified available energy threshold’; (f) ‘Run full bore, but when the battery is degrading pull back and reserve 10 days of energy to alert an operator for service’; and (e) ‘Tell me when operations are going to be compromised because of weather (e.g. snow) leading to less energy production’.

As previously mentioned, the present invention allows a system operator to tweak, change, or reconfigure the scheduled functionality and automatically re-optimize the battery use as the system energy usage changes.

The presentation invention is comprised of hardware and/or software components to enable: (a) Supply Characterization—what is the behavior of the power/energy supply; (b) Demand Characterization—what are the patterns of draw upon the power supply; (c) Prediction—under given supply/demand scenarios, how long will the power source last; (d) Demand Management—given behaviors and constraints of an energy model, plan power usage and implement it through managing system state; (e) System Hardware & Software—the normal system components operating under the power management scheme; (f) Optional interaction with Remote Node(s) to improve predictions; (g) may include peer IoT nodes and/or cloud-based/server nodes; (h) may send power management data to remote nodes; (f) may receive power management data from remote nodes; and (g) may receive additional data from remote servers, e.g. environmental data, weather, cloud cover, etc..

The IoT gateway device of the present invention is also able to measure attributes of the power plant including, (but not limited to): storage voltage; storage current; production voltage; production current; temperature; and other local parameters that aid in state estimation. The parameters to be measured will be determined by the algorithms used to estimate energy production, energy consumption, and state-of-charge as per the capabilities of the power plant and hardware. The system can store the measured parameters as they evolve over time in the Power Source History.

The system of the present invention can also observe and utilize the energy production measurements by using knowledge/parameterization of source and measured attributes, derive how much energy is being produced (recharge) and store time-series history. The system can also observe and store the energy consumption measurements by using knowledge/parameterization of source and measured attributes, derive how much energy is being consumed (demand) and store time-series history. The system can determine what the charging trend looks like over time and what does the discharge trend look like over time.

The system hardware includes several power-consuming resources that may be in different states at different times. The system software may request resources from the hardware, which results in those resources traversing through different power states in order for the hardware to meet the software request. For example: an ethernet port could be disabled, enabled but idle, or enabled and bearing traffic which results in three different power consuming states that the ethernet port could be in at any given time. Each such state is associated with an incremental power draw, e.g., 0 mW when disabled, 30 mW when idle, 100 mW when bearing traffic. The ethernet port will traverse the different states based on requests from system software and applications. Based on the amount of time the ethernet port spends in each state, and the baseline power draw in each state, the amount of energy spent in each state can be computed.

The system also provides or can incorporate a multi-dimensioned tuple that captures (envelopes) the average system power state as a function of various system hardware operating modes. Each contributing component of system hardware will be mapped to a sub-tuple within the system power state. For example, the Ethernet is disabled, the Ethernet is idle, the Ethernet is busy may be a 3-state sub-tuple within the System Power State. Further, for each CPU core what is the present clock state, is the cellular or mobile connectivity offline/online and at what access technology and data rate and each sub-tuple can be characterized as part of the hardware design validation and tweaked at runtime with Energy Consumption Measurements. Subsequently, when the system is in a given power state, the measurements can be applied to the power state to yield an estimation of present power consumption, and further to attribute system processes that are driving power consumption.

The system of the present invention can also maintain the System Power State per application needs and requests. The system may constrain the transitions of System Power State based on goals and constraints and the power management plan. The System Power State History can be periodic and/or on an event-driven basis where the System Power State will be sampled and recorded, producing a time-series record of the evolution of System Power State for later analysis. The time/sample resolution of the System Power State History need only be enough to drive the power management planning within a meaningful envelope—too high frequency may become intensive and meaningless (other errors dominate), and too low frequency may not provide meaningful ability to predict and optimize (not enough information). The tuning of the sampling rate will be an implementation and analysis exercise, which could be an iterative process, performed by the system.

The present invention can also perform a System Consumption Analysis where the IoT gateway device can extract consumption trends and drivers from the System Power State and decompose into periodic components if possible and find patterns. The present invention can create one or more models of the System Power Consumption under the typical operating condition and extract contributions from the typical drivers. The system can also attribute the application processes or subprocesses that are driving the consumption and extract their periodicity.

The IoT gateway device of the present invention can also determine an Energy State Estimation determining how much supply energy is available at a given instance. Given knowledge of the power plant, for example: (a) what is the supply technology; (b) What is the state of charge/discharge (e.g., is the supply fully charged); and (c) What is the fully charged capacity (for example: For a battery do we have a fully characterized IV curve as a function of state of charge, and can we estimate where we are on that curve). The present invention can also estimate the state of supply based on observed parameters and historical knowledge (i.e., how much energy is available for use now. The present invention can also re-sync estimations periodically by detecting key reference points/states in the discharge curve (e.g., ‘fully charged’).

Further, the present invention can determine the Energy Availability Forecast including: (a) How much supply energy will be available; and (b) How do we estimate this to evolve over time (near term, intermediate term). The system can also determine the System Consumption Forecast including: (a) In consultation with Energy Consumption Measurements and System Consumption Analysis, how much power do we expect to need over time in the future; and (b) What are the drivers to consume this power; and (c) If a given driver is added/removed/delayed how will it impact the forecast.

The present invention also provides a remote gateway device the device comprising: a device processor and device machine readable instructions on a non-transitory computer readable memory; a communication portion for receiving and transmitting a plurality of data; a processor performing processing, based on the device machine readable instructions; the instructions including a plurality of applications; wherein the communication portion receives a plurality of power plant data from a power plant connected to the device, wherein the power plant data includes a plurality of energy production data and plurality of energy consumption data; a system power consumption module for analyzing the power consumption requirements and power usage patterns of a plurality of software applications and a plurality of hardware resources resident on the device; a system power prediction module, wherein the system power prediction module uses the power consumption analysis from the system power consumption module and the plurality of energy prediction production data and the plurality of energy consumption data to forecast power consumption and generate a power management plan for the plurality of software applications and plurality of hardware resources resident on the device; a power control module for managing the power state of the plurality of software applications and the power state of the plurality of hardware resources resident on the device, wherein the power state module can limit power usage of the plurality of software applications and plurality of hardware resources resident on the device; and wherein the device implements the power management plan to control the plurality of software applications and plurality of hardware resources resident on the device based on the plurality of power plant data and power management plan.

Further, the remote gateway device where the power state module limits power usage to at least one of the plurality of software applications on the device by sending instructions to the at least one of the plurality of software applications. The remote gateway where the power state module limits power usage to at least one of the plurality of hardware resources on the device by sending a signal to the at least one of the plurality of hardware resources. The remote gateway device where at least one of the plurality of applications stores and analyzes time series persistent data derived from the plurality of energy production data and energy consumption data. The remote gateway device where the gateway device periodically assesses the power plant, updates the plurality of power plant data from the power plant, creates an updated power management plan based on the updated plurality of power plant data, and implements the updated power management plan. The remote gateway device where the gateway device periodically assesses the power plant, updates the plurality of power plant data from the power plant, creates an updated power management plan based on the updated plurality of power plant data, and implements the updated power management plan. The remote gateway device where the gateway device forecasts power plant energy availability and adjusts the power management plan to generate an updated power management plan. The remote gateway device where the gateway device forecasts system power consumption and adjusts the power management plan to generate an updated power management plan. The remote gateway device where the gateway device adjusts the power management plan when the power management plan does not meet a goal by adjusting the operations of at least one of the plurality of hardware components. The remote gateway device where the gateway device adjusts the power management plan when the power management plan does not meet a goal by adjusting the operations of at least one of the plurality of software applications. The remote gateway device where the gateway device communicates with a second gateway device, directly or through a server, to receive at least one of: (i) additional power plant data; (ii) power usage data; or (iii) power management plan data. The remote gateway device may also communicate with a server or servers to receive additional external data such as current or historical weather data, hardware data, and any admin or user provided data such as goals, priorities, or constraints for the device to utilize.

### BRIEF DESCRIPTION OF THE DRAWINGS

The following detailed description of the invention is better understood when read with reference to the drawings in which:

FIG. 1 provides an illustrative schematic overview of a system that implements a typical embodiment of the invention; and

FIG. 2 provides an illustrative schematic view of the detailed deconstruction of a system that implements a typical embodiment of the invention.

### DETAILED DESCRIPTION

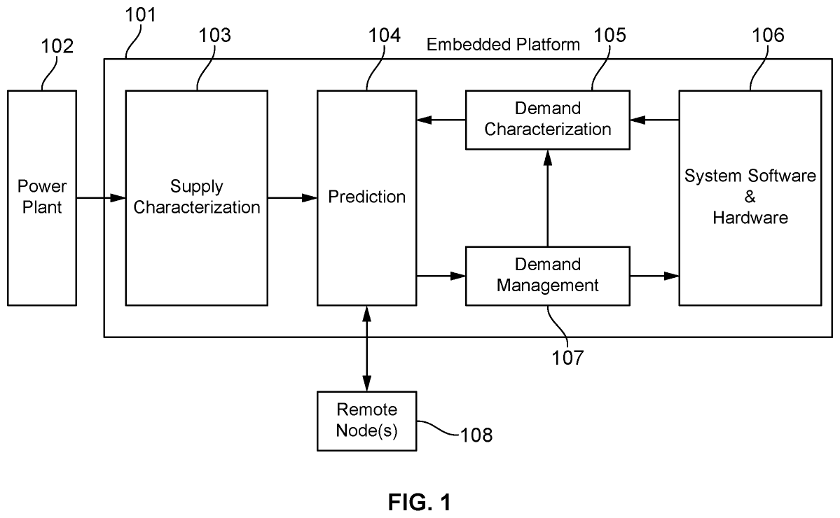

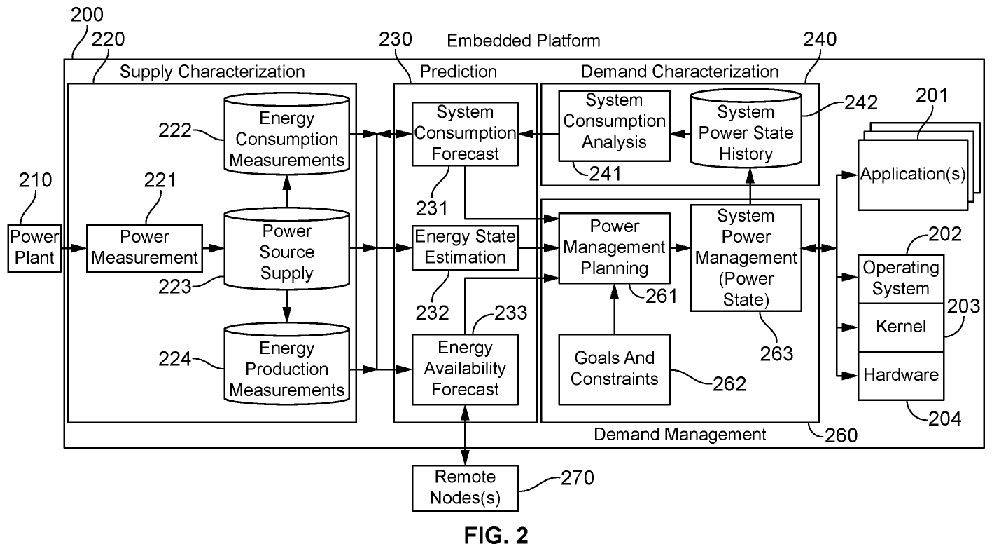

Hereinafter, aspects of the methods and associated systems in accordance with various embodiments of the invention will be described. As used herein, any term in the singular may be interpreted to be in the plural, and alternatively, any term in the plural may be interpreted to be in the singular. It is appreciated that features of one embodiment as described herein may be used in conjunction with other embodiments. The present invention can be more fully understood by reading the following detailed description together with the accompanying drawings (FIGS. 1-2), in which like reference indicators are used to designate like elements.

FIG. 1 depicts a high-level overview of a system that implements a typical embodiment of the present invention. The system of the present invention includes an embedded platform 101, consisting of hardware and software components, that implement the present invention. In the preferred embodiment, the embedded platform 101 is for example an IoT edge gateway or IoT edge device.

The IoT gateway 101 is connected to a power plant 102 that sources energy to the IoT gateway 101. The power plant 102 has a means to supply energy, may have a means to store energy, and may have a means to replenish the energy store. For example, 102 may be comprised of a solar panel, a battery, and a charge controller. In another example 102 may be a primary cell battery which is not rechargeable. Other examples may include a means for battery-backed main power. Other means to store energy such as capacitors could also be used. The power plant 102 is instrumented as feasible to measure parameters including but not limited to one or more of a subset of supply current, supply voltage, demand current, demand voltage, temperature, and operational state of a charge controller.

The IoT gateway 101 is comprised of a means of supply characterization 103, a means of demand characterization 105, a means of supply and demand prediction 104, a means of demand management 107. The IoT gateway 101 also includes other components of system hardware and software 106, the operation of which is influenced by the present invention.

The supply characterization element 103 interfaces with and to the power plant 102 from which it is able to take time-based measurements of supply status, optionally demand status, and optionally other parameters of the power plant depending on the technology used. The supply characterization element persistently maintains history of these time-based measurements. The supply characterization element makes this information available to the prediction element 104.

The demand characterization element 105 assesses and persistently stores time and event-based records of system driven power consumption, where such consumption is a consequence of the system hardware and software 106 behavior. Note that the supply characterization element 103 may be capable to observe and record aggregate energy demand as drawn from the power plant 102, but the demand characterization element 105 is able to track and store fine grained demand as correlated to the activation or deactivation of specific hardware and software processes. The demand characterization element 105 makes this information available to the predicting element 104. The demand characterization 105 is able to compute the fine-grained records of system power consumption based on interaction with the system hardware and software 106 and the demand management element 107.

The prediction element 104 is a software component that receives the time series history of supply characterization 103 and demand characterization 105 and implements computations to predict anticipated supply characteristics and demand characteristics based upon historical trends for both supply and demand, operations carried out by the system software and influence upon the system hardware, and optionally information from remote nodes 108. The prediction element 104 can compute how much energy is expected to be available, and how much energy is expected to be consumed over time under various operating parameters.

The system software and hardware element(s) 106 includes all software components that are not included in the software that implements the invention itself, such as application components and operating system components, and the underlying hardware that supports the embedded platform 101. The system software and hardware element 106 is instrumented to maintain fine-grained time domain power state of the hardware components and peripherals, as driven by software requests.

The demand management element 107 computes and derives a demand management plan or schema under provided goals and constraints given the supply characterization history, the demand characterization history, and predictive models. The demand management element 107 will iterate as necessary through various potential mandatory and discretionary power management controls in order to derive or arrive at a strategy or schema that will optimize the use of the power plant 102 under limited energy supply while prioritizing to complete as much of the application software use cases as need to be completed under the goals and constraints. The demand management element 107 will then signal mandatory and discretionary controls to the system hardware and software 106, or specific elements or components with the system hardware and software 106, to implement the power management plan.

FIG. 2 depicts a detailed deconstruction of a system that implements a typical embodiment of the present invention. As seen in FIG. 2, an embedded platform 101, consists of hardware and software components, used to implement the present invention.

The embedded platform 101 is connected to or interfaces with a power plant 102 that sources energy to the platform 101. The power plant 102 has a means to supply energy, may have a means to store energy, and may have a means to replenish the energy store. For example, 102 may be comprised of a solar panel, a battery, and a charge controller. In another example 102 may be a primary cell battery which is not rechargeable. Other examples may include a means for battery-backed main power. Other means to store energy such as capacitors could also be used. 102 is instrumented as feasible to measure parameters including but not limited to one or more of a subset of supply current, supply voltage, demand current, demand voltage, temperature, and operational state of a charge controller.

The supply characterization element 103 is further comprised of a power measurement element 221, a time series record of energy consumption measurements 222, a time series record of energy production measurements 224, and an overall history of the power source history 223. The power source history 223 records the aggregate state of energy availability over time, along with additional parameters such as temperature that may influence the energy availability when considered along with knowledge of the specific power plant 102 implementation, e.g., battery chemistry.

The demand characterization element 105 is further comprised of a system power state history 242 and a system consumption analysis 241. The system power state history 242 maintains a fine-grained historical record of how the system power state evolves over time. The system power state itself is determined by the system power management module 263. The system consumption analysis module 241 decomposes the system power state history 242 and attributes where possible time varying components of power consumption to application procedures and processes that are driving the power consumption.

The prediction element 104 is further comprised of a system consumption forecast 231, an energy state estimation 232, and an energy availability forecast 233. The system consumption forecast 231 will predictively extend the historical information from the system consumption analysis 241 in order to anticipate future power consumption needs under a given operational scenario with given application components. The energy state estimation 232 will model and predict the state of the power plant, e.g., the state of charge of a battery, based on inputs including the power source history 223 and additional system information as necessary such as temperature. The energy availability forecast will extend the energy state estimation to predict the future energy availability, further optionally incorporating information from remote nodes 108, such as remote IoT peer nodes installed in similar locations with similar operating conditions, and also optionally other information such as weather predictions. The prediction element 104 is thus able to model and compute, based on historical and system information, how much energy is expected to be available and also consumed over time by a system performing certain application processes and procedures.

The demand management element 107 is comprised of a power management planning element 261, a system power management or power state element 263, and a goals and constraints element 262 pertaining to power optimization. The system power management or power state vector element 263 may be a software module or hardware components and provides or represents a fine-grained view of each hardware component/peripheral that is under software control. For example, a cellular modem or an ethernet port may have several modes of operation and based on the mode of operation that they are in they will consume different amounts of power. As such peripherals transition through their modes of operation the system power state vector element 263 evolves to reflect those transitions. Inhibiting certain transitions of the power state vector effectively constrains the hardware to only operate within the selected subset of operational states, thus also extending a means of controlling how much power each hardware component/peripheral will be allowed to consume. The power management planning element 261 will consider goals and constraints in light of the predicted energy availability forecast and system consumption forecast in order to determine if the goals and constraints will be met. If the goals and constraints 262 are not met then the power management planning element 261 will permute a power management plan that includes assertion of mandatory and discretionary signals to the power management state, limiting or allowing the power management state to evolve under certain boundary conditions. Based on this permutation the power management element 261 can arrive at a strategy to balance the application needs under the goals and constrains against the expected energy available from the power plant. As the conditions of the power plant evolve over time, the power management plan is updated. As the requirements of application software changes over time, the power management plan is updated. Once a power management plan has been computed, it is applied by signaling mandatory and discretionary controls to the power management state and to the system hardware and software (201, 202, 203, 204). Mandatory signals will constrain the power management state from activating any hardware/peripheral component into a state that exceeds the power envelope as constrained by the mandatory signal. Discretionary controls are opt-in signals that are made available to applications 201 which may or may not choose to modify their behavior to meet the power management plan. If an application does not honor a discretionary control, a future evaluation of the power management plan may lead to a mandatory control.

Through use of the present invention, the IoT gateway device 101 can observe and learn the power plant 102, the power demands of the systems and components of the gateway device 102, connected peripherals, and remote but connected (wireless or wired) devices including other gateway devices 108. The gateway device 101 can then learn the energy usage patterns and/or demand requirements and predict how power consumption will be impacted by various modifications to usage of the systems and components. The gateway device 101 can then derive a plan or schema of utilization of the gateway components (software and hardware) based on the available power, power consumption analysis, and a system determined prioritization based on system goals and constraints. Finally, the gateway device 101 can implement the power utilization plan or schema by controlling which components or devices are activated, deactivated, and the frequency each component or device is activated or deactivated. Further, the gateway device 101 can communicate with other remote nodes or gateway devices 108 to receive data input on power plant data from those remote nodes 108, receive data on energy utilization plans or schema, and, if necessary, off load or take on activities to or from such connected nodes 108 to assist each gateway device 101 or each node 108 achieve required activities during energy managed time periods.

The systems and methods of the invention in described embodiments may be implemented as a system, method, apparatus or article of manufacture using programming and/or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may be further implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In an embodiment of the invention, the systems and methods use networks, wherein, the term, ‘networks’ means a system allowing interaction between two or more electronic devices, and includes any form of inter/intra enterprise environment such as the world wide web, Local Area Network (LAN), Wide Area Network (WAN), Storage Area Network (SAN) or any form of Intranet.

In an embodiment of the invention, the systems and methods can be practiced using any electronic device. An electronic device for the purpose of this invention is selected from any device capable of processing or representing data to a user and providing access to a network or any system similar to the internet, wherein the electronic device may be selected from but not limited to, personal computers, mobile phones, laptops, palmtops, tablets, portable media players and personal digital assistants.

As noted above, the processing machine used to implement the invention may be a suitable computer or other processing machine. The processing machine may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system (OS). Thus, embodiments of the invention may include a processing machine running the Unix operating system, the Apple iOS operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system (such as macOS™), the Apache operating system, an OpenStep™ operating system, the Android™ operating system (and variations distributed by Samsung, HTC, Huawei, LG, Motorola, Google, Blackberry, among others), the Windows 10™ operating system, the Windows Phone operating system, the Windows 8™ operating system, Microsoft Windows™ Vista™ operating system, the Microsoft Windows™ XP™ operating system, the Microsoft Windows™ NT™ operating system, the Windows™ 2000 operating system, or another operating system or platform.

The systems and methods of the invention may utilize non-operating systems (aka serverless architecture) as well for distributed processing. In the processing of the invention, services on cloud computing networks leveraging systems like AWS (as offered by Amazon Web Services, Inc.), BlueMix (as offered by IBM), and Microsoft Azure, can perform data collection services using varying technologies that are spun up on demand using tools like Chef to create container based deployments like Docker, or non-container compute services (e.g. AWS Lambda).

The invention may use or provide real-time analytics processing that may use scale on demand to the users in the system, in accordance with at least one embodiment of the invention. Such offerings as AWS Lambda and Kinesis (as offered by Amazon Web Services, Inc.) are among those that may be used in implementation of the invention. For example, AWS Lambda may be utilized to execute code (to perform processes of the invention) in response to various triggers including data changes, shifts in system state, or particular action taken by users. Similarly, in an embodiment, the OS (operating system) of the invention might be encapsulated in an EC2 instance (as offered by Amazon Web Services, Inc.) or multiple instances for deployment.

Another example of a traditional system is a device in the electrical distribution system that may speak a proprietary protocol or an older standardized protocol such as DNP3. In order to converge such a device to the modern grid it may be necessary to marshal its ‘native’ protocol into a new protocol such as IEC 61850. Further, is often desired to do so in such a way that allows security policy to be specified and enforced independently of the application behavior, and it is also often necessary to participate more fully in field-area networks that may require localized edge processing and interaction over other protocols with other devices at the edge such that a portion of the distribution system may reasonably take some action independently of coordination through a centralized head-end. The present invention allows such systems to be realized, by, for example, but not limited to 1) allowing domain experts to quickly and efficiently specify application layer behavior independently of deep protocol expertise, 2) allowing multiple protocols to be bound to that application via an abstract data set, which allows different protocols to transparently interact with elements in that data set as necessary, 3) allowing a natural partitioning of application logic independently of the underlying protocols, 4) allowing an architecture where protocol service behavior can be constrained by security policies (e.g. firewalling) independently of how an application layer will operate over that protocol.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner, such as over a network or over multiple networks. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, as also described above, various technologies may be used to provide communication between the various processors and/or memories, as well as to allow the processors and/or the memories of the invention to communicate with any other entity; i.e., so as to obtain further instructions or to access and use remote memory stores, for example. Such communication portion, component, system, or technologies used to provide such communication might include a network, the Internet, Intranet, Extranet, LAN, an Ethernet, wireless transceiver, a radio, or any client server system that provides communication, for example. Such communications technologies may use any suitable protocol such as TCP/IP, UDP, or OSI, for example.

Further, multiple applications may be utilized to perform the various processing of the invention. Such multiple applications may be on the same network or adjacent networks, and split between non-cloud hardware, including local (on-premises) computing systems, and cloud computing resources, for example. Further, the systems and methods of the invention may use IPC (interprocess communication) style communication for module level communication. Various known IPC mechanisms may be utilized in the processing of the invention including, for example, shared memory (in which processes are provided access to the same memory block in conjunction with creating a buffer, which is shared, for the processes to communicate with each other), data records accessible by multiple processes at one time, and message passing (that allows applications to communicate using message queues), for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, C#, Objective C, COBOL, dBase, Forth, Fortran, Java, Modula-2, Node.JS, Pascal, Prolog, Python, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, as also described above, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

1. A remote gateway device the device comprising:
a device processor and device machine readable instructions on a non-transitory computer readable memory;
a communication portion for receiving and transmitting a plurality of data;
a processor performing processing, based on the device machine readable instructions;
the instructions including a plurality of applications;
wherein the communication portion receives a plurality of power plant data from a power plant connected to the device, wherein the power plant data includes a plurality of energy production data and plurality of energy consumption data;
a system power consumption module for analyzing the power consumption requirements and power usage patterns of a plurality of software applications and a plurality of hardware resources resident on the device;
a system power prediction module, wherein the system power prediction module uses the power consumption analysis from the system power consumption module and the plurality of energy prediction production data and the plurality of energy consumption data to forecast power consumption and generate a power management plan for the plurality of software applications and plurality of hardware resources resident on the device;
a power control module for managing the power state of the plurality of software applications and the power state of the plurality of hardware resources resident on the device, wherein the power state module can limit power usage of the plurality of software applications and plurality of hardware resources resident on the device; and
wherein the device implements the power management plan to control the plurality of software applications and plurality of hardware resources resident on the device based on the plurality of power plant data and power management plan.

2. The remote gateway device of claim 1, wherein the power state module limits power usage to at least one of the plurality of software applications on the device by sending instructions to the at least one of the plurality of software applications.

3. The remote gateway device of claim 1, wherein the power state module limits power usage to at least one of the plurality of hardware resources on the device by sending a signal to the at least one of the plurality of hardware resources.

4. The remote gateway device of claim 1, wherein at least one of the plurality of applications stores and analyzes time series persistent data derived from the plurality of energy production data and energy consumption data.

5. The remote gateway device of claim 1, wherein gateway device periodically assesses the power plant, updates the plurality of power plant data from the power plant, creates an updated power management plan based on the updated plurality of power plant data, and implements the updated power management plan.

6. The remote gateway device of claim 1, wherein gateway device periodically assesses the power plant, updates the plurality of power plant data from the power plant, creates an updated power management plan based on the updated plurality of power plant data, and implements the updated power management plan.

7. The remote gateway device of claim 1, wherein gateway device forecasts power plant energy availability and adjusts the power management plan to generate an updated power management plan.

8. The remote gateway device of claim 1, wherein gateway device forecasts system power consumption and adjusts the power management plan to generate an updated power management plan.

9. The remote gateway device of claim 1, wherein gateway device adjusts the power management plan when the power management plan does not meet a goal by adjusting the operations of at least one of the plurality of hardware components.

10. The remote gateway device of claim 1, wherein gateway device adjusts the power management plan when the power management plan does not meet a goal by adjusting the operations of at least one of the plurality of software applications.
